(19) United States
(12) Patent Application Publication
(10) Pub. No.: US 2010/0238996 A1
(43) Pub. Date: Sep. 23, 2010

(54) MOBILE TERMINAL AND VIDEO OUTPUT METHOD

(75) Inventors: Ryoichi Murata, Kanagawa (JP); Tetsu Hada, Kanagawa (JP); Toshihiro Sakatsume, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Kadoma-shi, Osaka (JP)

(21) Appl. No.: 12/743,080

(22) PCT Filed: Nov. 16, 2007
(86) PCT No.: PCT/JP2007/072320

§ 371 Date: May 14, 2010

(51) Int. Cl. H04N 11/02

(52) U.S. Cl. 375/240.01

(57) ABSTRACT

The present invention provides a mobile terminal that can accomplish power saving of power consumption involved in decode processing, and that can shorten the time required until the video signal corresponding to the point is output to the display even if playback is executed at any desired point in moving image data. When a stream control section 19 detects a decode start trigger, a video decoding section 15 starts decode with a key frame of a video frames as a start point, the key frame being synchronized with an audio frame decoded by a sound decoding section 12. When the stream control section 19 detects display operation, a video output section 16 starts output with a first video signal as a start point, the first video signal being synchronized with a sound signal output by a sound output section 14.

### TECHNICAL FIELD

The present invention relates to a mobile terminal that can play back digital video and a digital video output method of the mobile terminal.

### BACKGROUND ART

In recent years, an occasion of playing back moving image data whose data amount is comparatively large has increased in accordance with an increase in the storage capacity of storage in stalled in a mobile terminal or broadcast start of digital TV broadcast.

To play back moving image data, when the mode switches from a mode of playing back only an audio frame forming the moving image data to a mode of playing back an audio frame and a video frame forming the moving image data, the mobile terminal needs to perform decode processing of the video frame. If decode processing is executed after operation of giving a playback command of a video frame (the switch operation mentioned above), output of a video signal to a display is delayed as much as the time required for the decode processing (specifically, as much as the time required until an I frame used as the reference for decoding a P frame is decoded). On the other hand, if the mobile terminal executes decode processing before accepting operation of giving a playback command of a video frame, the mobile terminal can output a video signal on the display at the same time as acceptance of the operation, but it is also necessary to execute decode processing for a video frame not output to the display, and power consumption involved in the decode processing increases. Considering shortening of the time required until a video signal is output to the display and power saving of power consumption involved in the decode processing, Patent Documents 1 and 2 disclose the following apparatus:

When accepting operation of giving a playback command of a video frame, a moving image decoding apparatus disclosed in Patent Document 1 decodes the top video frame and outputs the decoded video signal (still image) and advances later video frames decoding while outputting the signal to the display.

A folded mobile telephone disclosed in Patent Document 2 is a mobile telephone that can receive TV broadcast. When the mobile telephone is operated from an unfolded state to a folded state, output of a video signal to a display is stopped, whereas output of a sound signal to a loudspeaker is continued.

### Patent Document 1: JP-3-228490A

### Patent Document 2: JP-2005-94418A

### DISCLOSURE OF THE INVENTION

### Problems to be Solved by the Invention

However, although the moving image decoding apparatus disclosed in Patent Document 1 can shorten the time required until the video signal is output to the display, a screen output to the display becomes uniformly a still image based on the top video frame. Playback may be executed at any desired point of a video frame; in this case, a still image not relevant to the video corresponding to the desired point is displayed on the display, and thus the display lacks consistency.

The folded mobile telephone disclosed in Patent Document 2 makes possible power saving of power consumption involved in the decode processing; however, when the mobile telephone is operated from the folded state to the unfolded state, output of the video signal to the display is sill delayed as much as the time required for the decode processing.

In view of the circumstances described above, it is an object of the present invention to provide a mobile terminal and a digital video output method wherein while power saving of power consumption involved in decode processing is accomplished, if playback is executed at any desired point in video frames, the time required until the video signal corresponding to the point is output to the display can be shortened.

### Means for Solving the Problems

A mobile terminal according to the present invention is configured by comprising: a sound decoding section that is adapted to sequentially decode audio frames forming a sound; a sound output section that is adapted to output a sound signal decoded by the sound decoding section; a video decoding section that is adapted to sequentially decode video frames forming a moving image; a decode trigger detection section that is adapted to detect a decode start trigger for causing the video decoding section to start decoding the video frames; a video output section that is adapted to output a video signal decoded by the video decoding section; and a display operation detection section which is adapted to detect display operation for causing the video output section to start outputting the video signal, wherein when the decode trigger detection section detects the decode start trigger, the video decoding section starts decoding with a key frame of the video frames as a start point, the key frame being synchronized with the audio frame decoded by the sound decoding section, and when the display operation detection section detects the display operation, the video output section starts output with a first video signal as a start point, the first video signal being synchronized with the sound signal output by the sound output section.

A video output method according to the present invention comprises the steps of: decoding audio frames forming a sound; outputting a decoded sound signal; detecting a decode start trigger for starting decode of video frames forming a moving image; starting decode from a key frame of the video frames, synchronized with the decoded audio frame upon detection of the decode start trigger; detecting display operation for starting output of a decoded video signal; and starting output from the video signal synchronized with the output sound signal.

According to these configurations, while power saving of power consumption involved in decode processing is accomplished, if playback is executed at any desired point in moving image data, the time required until the video signal corresponding to the point is output to the display can be shortened.

The mobile terminal according to the present invention also includes the configuration, wherein if the display operation detection section detects the display operation before the video decoding section starts decoding with the key frame of the video frame as the start point, the video output section outputs a second video signal different from the first video signal.

The mobile terminal according to the present invention also includes the configuration, wherein the second video signal is a video signal decoded by the video output section before the decode trigger detection section detects the decode start trigger.

Accordingly, there can be an occasion of outputting a video signal not output because the user does not perform display operation although the signal is decoded, so that the video signal can be used effectively.

The mobile terminal according to the present invention also includes the configuration, wherein if the display operation detection section does not detect the display operation within a predetermined time since detection of the decode start trigger by the decode trigger detection section, the video decoding section stops decode of the video frames.

The mobile terminal according to the present invention also includes the configuration, wherein if the decode trigger detection section detects a decode termination trigger for terminating decode of the video frame of decode, the video decoding section stops decode of the video frame.

The video output method according to the present invention includes the configuration comprising the steps of: detecting a decode termination trigger for terminating decode being executed; and terminating the video frame decode being executed upon detection of the decode termination trigger.

According to these configurations, power consumption involved in decode of a video frame performed before display operation is detected can be suppressed.

The mobile terminal according to the present invention also includes the configuration, wherein the display operation detection section detects start of the video output section as the display operation.

The mobile terminal according to the present invention also includes the configuration, wherein the display operation detection section detects, as the display operation, switch of display from a first display screen generated by executing an application program to a second display screen for outputting the video signal by the video output section.

The mobile terminal according to the present invention also includes the configuration, wherein the decode trigger detection section detects, as the decode start trigger, either or both of a change in tune or a change in sound, of the sound signal decoded by the sound decoding section.

The mobile terminal according to the present invention also includes the configuration, wherein the decode trigger detection section detects, as the decode start trigger, a point in time to decode a predetermined frame of the audio frames or the video frames specified by content information concerning moving image content including the audio frames and the video frames.

The mobile terminal according to the present invention also includes the configuration, wherein the decode trigger detection section detects, as the decode start trigger, termination of display of the first display screen generated by executing the application program.

The mobile terminal according to the present invention also includes the configuration, wherein the mobile terminal comprises a sensor which is adapted to sense change in behavior of a user and a change in environment in which the mobile terminal is placed, wherein the decode trigger detection section detects, as the decode start trigger, a change in a signal input from the sensor.

According to these configurations, what timing the video display operation during playback of only a sound performed by the user is performed at can be detected previously.

### ADVANTAGES OF THE INVENTION

According to the mobile terminal and the video output method of the invention, while power saving of power consumption involved in decode processing is accomplished, if playback is executed at any desired point in moving image data, the time required until the video signal corresponding to the point is output to the display can be shortened.

### BRIEF DESCRIPTION OF THE DRAWINGS

FIG. 1 is a function block diagram of a mobile terminal according to an embodiment of the invention.

FIG. 2 is a conceptual drawing of decode processing of the mobile terminal according to the embodiment of the invention.

FIG. 3 is a flowchart to show a flow of video output by the mobile terminal according to the embodiment of the invention.

FIG. 4 is a flowchart to show a flow of video output by the mobile terminal according to the embodiment of the invention.

FIG. 5 is a flowchart to show a flow of detection processing of decode start/termination trigger by the mobile terminal according to the embodiment of the invention.

### DESCRIPTION OF REFERENCE NUMERALS AND SIGNS

11 Data format analysis section
12 Sound decoding section
13 Sound analysis section
14 Sound output section
15 Video decoding section
16 Video output section
17 Application section
18 External sensor
19 Stream control section

### BEST MODE FOR CARRYING OUT THE INVENTION

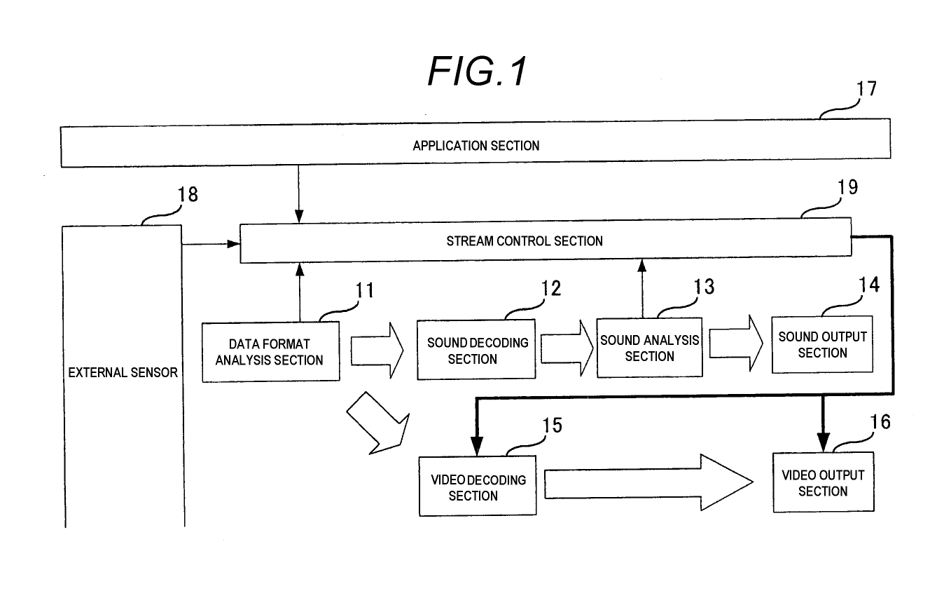

A mobile terminal according to an embodiment of the invention and a video output method of the mobile terminal will be described below in detail: FIG. 1 is a function block diagram of the mobile terminal according to the embodiment of the invention. The mobile terminal according to the embodiment of the invention includes a data format analysis section 11, a sound decoding section 12, a sound analysis section 13, a sound output section 14, a video decoding section 15, a video output section 16, an application section 17, an external sensor section 18, and a stream control section 19. In FIG. 1, each outline arrow directed from the data format analysis section 11 to the sound output section 14 or the video output section 16 represents a stream of an audio frame or a sound signal and a video frame or a video signal; each arrow (thin line) directed to the stream control section 19 represents a flow of a control signal from the section of the origin of the arrow to the stream control section 19; and each arrow (thick line) directed from the stream control section 19 to the video decoding section 15 or the video output section 16 represents a flow of a drive control signal from the stream control section 19 to the video decoding section 15 or the video output section 16.

The data format analysis section 11 analyzes moving image data input from storage (not shown in figure) and a digital TV broadcast receiver (not shown in figure) included in the mobile terminal according to the embodiment of the invention. The moving image data refers to a set of each audio frame, each video frame, control data concerning playback control of the audio frame or the video frame, and content data concerning the moving image data (information specifying any desired point of moving image data in which the user viewing the moving image data can have interest, such as time information on the moving image data specified as an important point by the creator of the moving image data, for example) (the control data may be described in a header of an audio frame or a video frame and the content data may be in a separate file format from the moving image data). The data format analysis section 11 references the control data of the moving image data and sequentially outputs audio frames to the sound decoding section 12 and video frames to the video decoding section 15. The data format analysis section 11 also references the time information described in the content data (which may be hereinafter called cutout point). If the audio frame output to the sound decoding section 12 or the video frame output to the video decoding section 15 has a time stamp corresponding to the time information or when the time information corresponds to the start time of the catchy part of a music piece, or if the frame has a time stamp corresponding to the time information several seconds before the time information, the data format analysis section 11 outputs a control signal for making a request for starting decoding of the video frame to the stream control section 19.

The sound decoding section 12 decodes the audio frame input from the data format analysis section 11 and outputs the decoded sound signal to the sound analysis section 13 and the sound output section 14. The decode processing of the sound decoding section 12 conforms to MPEG (Moving Picture Expert Group) standard, for example.

The sound analysis section 13 analyzes a sound signal input from the sound decoding section 12, and if it determines that the sound signal has a feature point, the sound analysis section 13 outputs a control signal for making a request for starting decoding of the video frame to the stream control section 19. As a determination algorithm of the presence or absence of the feature point by the sound analysis section 13, an already existing algorithm of determining the feature point based on the sound volume, the frequency, pattern matching is used.

The sound output section 14 corresponds to a speaker and inputs a sound signal decoded by the sound decoding section 12 and outputs a sound based on the sound signal.

While a drive control signal for making a request for decoding a video frame is input from the stream control section 19, the video decoding section 15 decodes the video frame input from the data format analysis section 11 and outputs the decoded video signal to the video output section 16. On the other hand, while the video decoding section 15 does not input the drive control signal from the stream control section 19, the video decoding section 15 does not input the video frame output from the data format analysis section 11, or a video frame is not decoded even when the video frame is input, whereby power is saved. The decode processing of the video decoding section 15 conforms to MPEG (Moving Picture Expert Group) standard, for example.

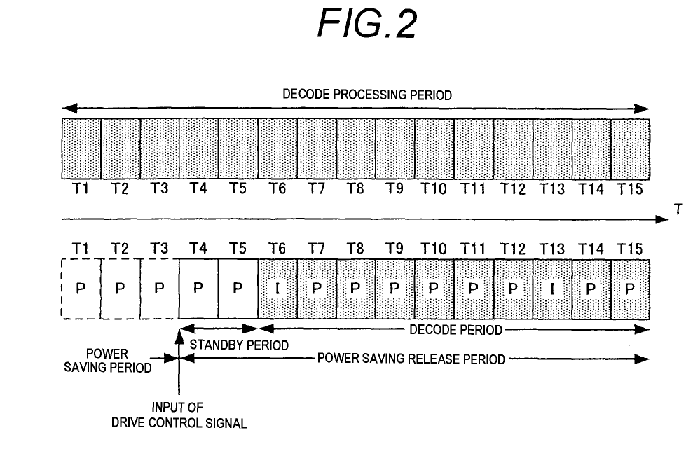

The decode processing of the video decoding section 15 will be described with reference to a conceptual drawing of decode processing of the mobile terminal according to the embodiment of the invention shown in FIG. 2. Adjacent rectangles at the upper stage shown in FIG. 2 represent audio frames decoded by the sound decoding section 12 and those at the lower stage represent video frames decoded by the video decoding section 15. The screened rectangles represent audio frames decoded by the sound decoding section 12 or video frames decoded by the video decoding section 15. In FIG. 2, it is assumed that time stamps T1 to T15 are assigned to the audio frames or the video frames.

The sound decoding section 12 sequentially decodes audio frames output to the sound decoding section 12 according to the order of the time stamps by the data format analysis section 11. On the other hand, the video decoding section 15 does not input or decode the video frame output to the video decoding section 15 (in FIG. 2, video frames with time stamps T1 to T3) according to the order of the time stamps by the data format analysis section 11 at the period until input of the drive control signal for making a request for decoding a video frame from the stream control section 19 (power saving period in FIG. 2). The video decoding section 15 executes the following decode processing at the period of input of the drive control signal for making a request for decoding a video frame from the stream control section 19 (power saving release period in FIG. 2):

When the video decoding section 15 inputs the drive control signal for making a request for decoding a video frame from the stream control section 19, it starts to input a video frame output to the video decoding section 15 according to the order of the time stamps by the data format analysis section 11 and waits for an I frame of the video frame (in FIG. 2, the period until input of the I frame is described as standby period). In an encode system conforming to the MPEG standard, for example, in MPEG4, a video signal is compressed to I frame and P frame. Of the frames thus compressed, the I frame is decoded to a video signal with information only of the I frame. On the other hand, the P frame is difference information between the data of the P frame and the data of the I frame with the earlier time stamp than P frame and is decoded to a video signal with information of the data of the P frame and the I frame immediately preceding the P frame. The I frame has a function which becomes the reference for decoding the P frame and thus may be called a key frame. When the video decoding section 15 inputs the I frame (in FIG. 2, the video frame with the time stamp T6) of the video frames output to the video decoding section 15 according to the order of the time stamps by the data format analysis section 11, the video decoding section 15 decodes the I frame and whenever it inputs a P frame following the I frame (in FIG. 2, each video frame on and after the time stamp T7, the video decoding section 15 references the I frame (the video frame with the time stamp T6) and decodes the P frame (in FIG. 2, the period decoding the I frame and the P frames is described as decode period).

While the video output section 16 inputs a drive control signal for making a request for outputting a video signal from the stream control section 19, the video output section 16 performs video output based on a video signal input from the video decoding section 15. On the other hand, while the video output section 16 does not input the drive control signal from the stream control section 19, the video output section 16 does not perform video output of a video signal input from the video decoding section 15.

The application section 17 executes an application program stored in storage (not shown in figure) and outputs a generated video signal to the video output section 16 and causes the video output section 16 to perform video output. The application section 17 references an application program and generates a video signal which differs from a video signal decoded and generated by the video decoding section 15 and outputs the generated signal to the video output section 16. The application section 17 references an input signal accepted from an operation key (not shown in figure) and executes the application program. At the time, when the application section 17 executes processing of terminating generation of a video signal by one application program or predicted processing of terminating (they may be called application termination processing), such as acceptance of an input signal for stopping the application program (for example, a signal for making a request for closing the application program such as a calculator, a memo pad, or a telephone directory), switching to another window output by a different application program, arrival of screen scroll to the end, or completion of execution of application program (for example, completion of download or arrival to a turning point in a game program), the application section 17 outputs a control signal for making a request for starting decode of video frame to the stream control section 19.

The external sensor section 18 determines a change in the behavior of the user or a change in the environment wherein the mobile terminal is placed based on a signal detected by various sensors of an acceleration sensor, a piezoelectric sensor, etc., (containing general devices for converting some stimulus added from the outside into an electric signal). If the external sensor section 18 determines the presence of change, it outputs a control signal for making a request for starting decode of video frame to the stream control section 19. For example, if the signal detected by the acceleration sensor becomes larger than a threshold value, the external sensor section 18 assumes that the user takes out the mobile terminal and determines that the user not operating the mobile terminal starts to operate the mobile terminal. The external sensor section 18 determines that the user not operating the mobile terminal starts to operate the mobile terminal from the measurement situation of the reception strength executed by a wireless section (not shown in figure) used for wireless communications by the mobile terminal and the situation of handover.

When the stream control section 19 inputs a control signal for making a request for starting decode of video frame from at least one of the data format analysis section 11, the sound analysis section 12, the application section 17, and the external sensor section 18, the stream control section 19 outputs a drive control signal for making a request for decoding a video frame to the video decoding section 15. When accepting operation for making a request for outputting moving image data from the user, the stream control section 19 outputs a drive control signal for making a request for outputting a video signal to the video output section 16.

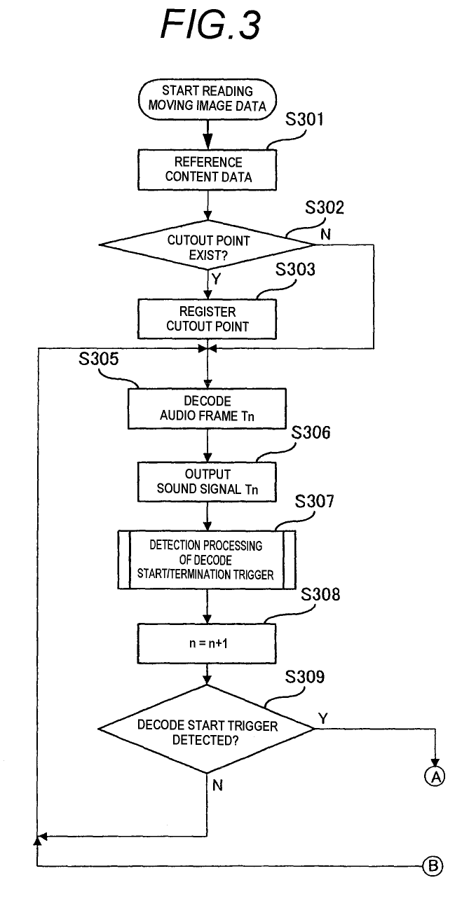

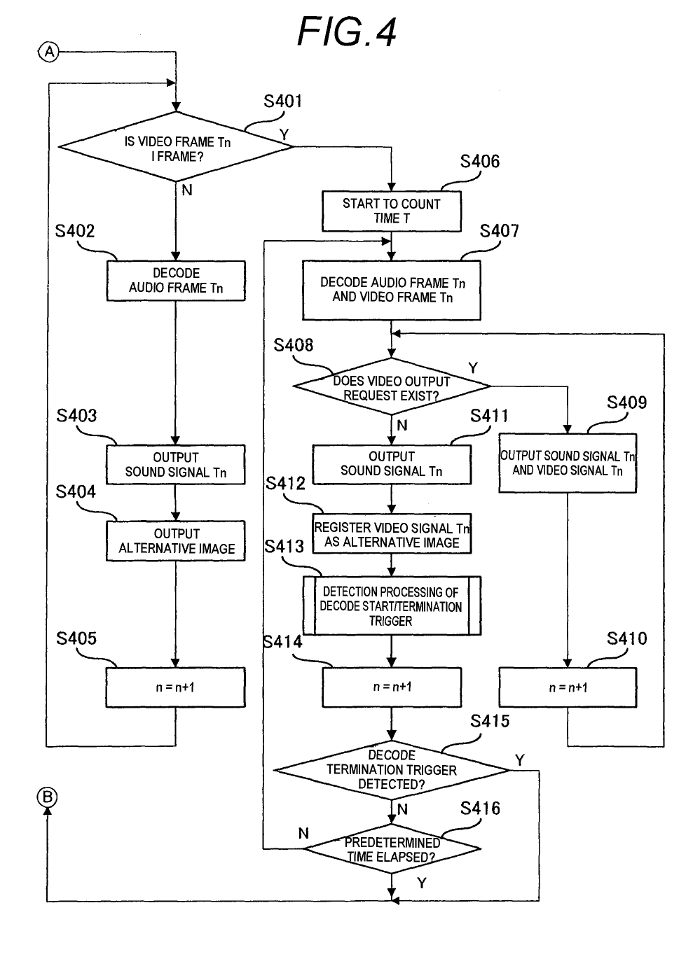

Next, a flow of video output by the mobile terminal according to the embodiment of the invention will be described with reference to flowcharts to show a flow of video output by the mobile terminal according to the embodiment of the invention, shown in FIGS. 3 and 4.

The mobile terminal according to the embodiment of the invention stores moving image data and performs playback processing of an audio frame of the moving image data. When starting to read moving image data, first the mobile terminal references data described in content data (step 301) and determines the presence or absence of a cutout point (step 303). If a cutout point exists (Y at step 302), the mobile terminal registers the cutout point (step 303).

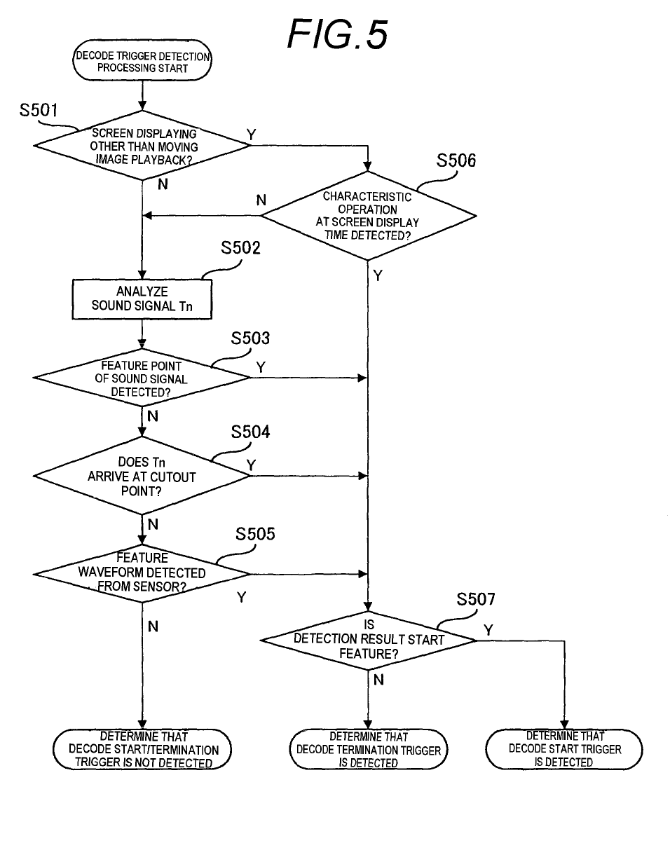

If a cutout point does not exist in content data (N at step 302) or after the cutout point is registered (step 303), the mobile terminal decodes the audio frame to which the time stamp T1 is assigned (step 305) and outputs the sound signal T1 (step 306). After this, the mobile terminal executes detection processing of a decode start/termination trigger shown at step 307. FIG. 5 is a flowchart to show a flow of detection processing of decode start/termination trigger by the mobile terminal according to the embodiment of the invention.

The mobile terminal determines whether or not screen display other than moving image playback is output to a display at the point in time (step 501). If screen display other than moving image playback generated by executing an application program is not output to the display (N at step 501), the mobile terminal analyzes decoded and generated sound signal Tn (step 502) and determines whether or not a feature point exists in the sound signal Tn (step 503). After this, the mobile terminal determines whether or not time stamp Tn matches the time corresponding to the cutout point (step 504) and further determines the presence or absence of a change in the behavior of the user or a change in the environment wherein the mobile terminal is placed based on a signal input from the external sensor (step 505). On the other hand, if the mobile terminal determines at step 501 that screen display other than moving image playback is output to the display by executing the application program (Y at step 501), the mobile terminal determines the presence or absence of application termination processing of stopping the application program, arrival of screen scroll at the end, completing execution of the application program, etc., (step 506). If the mobile terminal detects the corresponding event in processing at any of step 503, 504, 505, or 506, it determines that a decode trigger is detected; if the mobile terminal cannot detect the corresponding event in processing at any of steps, it determines that a decode trigger cannot be detected. If the mobile terminal detects a decode trigger, it determines whether the decode trigger is a trigger as a start condition of decode (which will be hereinafter called decode start trigger) or a trigger as a termination condition of decode being executed (which will be hereinafter called decode termination trigger) (step 507).

As the difference between the decode start trigger and the decode termination trigger, in processing at step 503, change from a state in which a feature point does not exist in the sound signal Tn to a state in which a feature point exists corresponds to the decode start trigger, and change from a state in which a feature point exists in the sound signal Tn to a state in which a feature point does not exist corresponds to the decode termination trigger. In processing at step 504, the time of a start point and the time of a termination point are set in the cutout point and the time of the start point corresponds to the decode start trigger and the time of the termination point corresponds to the decode termination trigger. In processing at step 505, change from a state in which a change does not exist in the input signal from the sensor to a state in which a change exists corresponds to the decode start trigger and a change from a state in which a change exists to a state in which a change does not exist corresponds to the decode termination trigger. In processing at step 506, detection of application termination processing corresponds to the decode start trigger and detection of application start processing corresponds to the decode termination trigger.

After the detection processing of the decode start/termination trigger, the mobile terminal increments the time stamp T1 by one to be time stamp T2 (step 308) and determines whether or not the decode start trigger is detected (step 309) in the detection processing of the decode start/termination trigger. After this, while incrementing the time stamp by one to be the next time stamp in processing at step 308, the mobile terminal repeats processing from step 305 to step 309 until detection of the decode start trigger.

If the mobile terminal determines that the decode start trigger is detected (Y at step 309) in the detection processing of the decode start/termination trigger, the mobile terminal starts decode processing of the video frame of the moving image data (to “A”).

The mobile terminal references the time stamp Tn when the decode start trigger is detected at step 307, determines the video frame to which the time stamp Tn is assigned, and determines whether or not the video frame is an I frame (step 401). If the determined video frame is not an I frame (N at step 401), the mobile terminal decodes only the audio frame to which the time stamp Tn is assigned (step 402), outputs decoded and generated sound signal Tn (step 403), and increments the time stamp by one to be the time stamp Tn (step 405). While the mobile terminal outputs the sound signal Tn, it may display a previously decoded still image or moving image (alternative image. Generation processing of the alternative image will be described later in processing at step 412) (step 404).

On the other hand, if the determined video frame is an I frame (Y at step 401), the mobile terminal starts to count the time (step 406) and decodes the audio frame and the video frame to which the time stamp Tn is assigned (step 407).

When the mobile terminal accepts a signal for making a request for outputting moving image data by display operation such as key operation or open operation of flip (a signal for making a request for outputting a video signal) (Y at step 408), the mobile terminal outputs the decoded and generated sound signal Tn and video signal Tn (step 409) and increments the time stamp by one to the time stamp Tn (step 410). If the mobile terminal does not accept a signal for making a request for outputting moving image data by display operation such as key operation or open operation of flip (a signal for making a request for outputting a video signal) (N at step 408), the mobile terminal outputs only the decoded and generated sound signal Tn (step 411), performs detection processing of decode start/termination trigger (step 413), and increments the time stamp by one to be the time stamp Tn (step 414).

If the mobile terminal does not accept a signal for making a request for outputting moving image data (a signal for making a request for outputting a video signal) (N at step 408), the mobile terminal may store the sound signal decoded at step 407 as an alternative image (step 412). Accordingly, there can be an occasion of outputting a video signal not output because the user does not perform display operation although the signal is decoded in the standby period shown in FIG. 2, whereby the video signal can be used effectively.

If the decode termination trigger cannot be detected (N at step 415) after the time stamp is incremented by one to be the time stamp Tn in processing at step 414 or if the time counted in processing at step 406 is less than a predetermined time (N at step 416), the mobile terminal repeats processing from step 407 to step 416. On the other hand, if the decode termination trigger is detected (Y at step 415) or if the time counted in processing at step 406 exceeds the predetermined time (Y at step 416), the mobile terminal stops decoding of the later video frames and goes to processing at step 305 (to “B”).

The processing at step 416 means that when the decode period shown in FIG. 2 becomes a predetermined time or more while the user does not perform display processing, a transition is made to the power saving period for waiting for detection of a decode start trigger. Accordingly, power consumption involved in decode of a video frame can be suppressed.

As described above, according to the mobile terminal of the embodiment of the invention, while power saving of power consumption involved in decode processing is accomplished, if playback is executed at any desired point in moving image data, the time required until the video signal corresponding to the point is output to the display can be shortened.

While the invention has been described in detail with reference to the specific embodiments, it will be obvious to those skilled in the art that various changes and modifications can be made without departing from the spirit and the scope of the invention.

### INDUSTRIAL APPLICABILITY

According to the mobile terminal and the video output method of the invention, the invention provides the advantage that while power saving of power consumption involved in decode processing is accomplished, if playback is executed at any desired point in moving image data, the time required until the video signal corresponding to the point is output to the display can be shortened, and the invention is useful in the field of the mobile terminal that can play back digital video.

1. A mobile terminal comprising:
a sound decoding section that is adapted to sequentially decode audio frames forming a sound;
a sound output section that is adapted to output a sound signal decoded by the sound decoding section;
a video decoding section that is adapted to sequentially decode video frames forming a moving image;
a decode trigger detection section that is adapted to detect a decode start trigger for causing the video decoding section to start decoding the video frames;
a video output section that is adapted to output a video signal decoded by the video decoding section; and
a display operation detection section which is adapted to detect display operation for causing the video output section to start outputting the video signal, wherein
when the decode trigger detection section detects the decode start trigger while decoding by the sound decoding section and stopping decoding by the video decoding section, the video decoding section starts decoding with a key frame of the video frames as a start point, the key frame being synchronized with the audio frame decoded by the sound decoding section, and
when the display operation detection section detects the display operation, the video output section starts output with a first video signal as a start point, the first video signal being synchronized with the sound signal output by the sound output section.

2. The mobile terminal as claimed in claim 1, wherein
if the display operation detection section detects the display operation before the video decoding section starts decoding with the key frame of the video frame as the start point, the video output section outputs a second video signal different from the first video signal.

3. The mobile terminal as claimed in claim 2, wherein
the second video signal is a video signal decoded by the video output section before the decode trigger detection section detects the decode start trigger.

4. The mobile terminal as claimed in claim 1, wherein
if the display operation detection section does not detect the display operation within a predetermined time since detection of the decode start trigger by the decode trigger detection section, the video decoding section stops decode of the video frames.

5. The mobile terminal as claimed in claim 1, wherein
if the decode trigger detection section detects a decode termination trigger for terminating decode of the video frame of decode, the video decoding section stops decode of the video frame.

6. The mobile terminal as claimed in claim 1, wherein
the display operation detection section detects start of the video output section as the display operation.

7. The mobile terminal as claimed in claim 1, wherein
the display operation detection section detects, as the display operation, switch of display from a first display screen generated by executing an application program to a second display screen for outputting the video signal by the video output section.

8. The mobile terminal as claimed in claim 1, wherein
the decode trigger detection section detects, as the decode start trigger, either or both of a change in tune or a change in sound, of the sound signal decoded by the sound decoding section.

9. The mobile terminal as claimed in claim 1, wherein
the decode trigger detection section detects, as the decode start trigger, a point in time to decode a predetermined frame of the audio frames or the video frames specified by content information concerning moving image content including the audio frames and the video frames.

10. The mobile terminal as claimed in claim 7, wherein
the decode trigger detection section detects, as the decode start trigger, termination of display of the first display screen generated by executing the application program.

11. The mobile terminal as claimed in claim 1, comprising
a sensor which is adapted to sense change in behavior of a user and a change in environment in which the mobile terminal is placed, wherein
the decode trigger detection section detects, as the decode start trigger, a change in a signal input from the sensor.

12. A video output method comprising the steps of:
decoding audio frames forming a sound;
outputting a decoded sound signal;
detecting a decode start trigger for starting decode of video frames forming a moving image;
starting decode from a key frame of the video frames, synchronized with the decoded audio frame upon detection of the decode start trigger while decoding the audio frames and stopping decoding the video frames;
detecting display operation for starting output of a decoded video signal; and
starting output from the video signal synchronized with the output sound signal.

13. The video output method as claimed in claim 12 comprising the steps of:
detecting a decode termination trigger for terminating decode being executed; and
terminating the video frame decode being executed upon detection of the decode termination trigger.
